(19) United States
(12) Patent Application Publication
(10) Pub. No.: US 2025/0301260 A1
(43) Pub. Date: Sep. 25, 2025

(54) WIRELESS SIDETONE SYSTEM FOR DESKTOP MICROPHONES AND HEADSETS

(71) Applicant: SKYWORKS SOLUTIONS, INC., Irvine, CA (US)

(72) Inventor: Shawn William Scarlett, San Francisco, CA (US)

(21) Appl. No.: 19/085,008

(22) Filed: Mar. 20, 2025

Related U.S. Application Data
(60) Provisional application No. 63/567,655, filed on Mar. 20, 2024.

(51) Int. Cl. H04R 3/00; H04R 1/10

(52) U.S. Cl. CPC H04R 3/005; H04R 1/1041; H04R 2201/109; H04R 2420/07

(57) ABSTRACT

A system is provided for processing audio. The system includes a headset having an audio output and a wireless receiver; and a microphone having a first audio input, a second audio input, a mixing circuit, and a wireless transmitter, the first audio input configured to receive a first audio signal and provide the first audio signal to the mixing circuit, the second audio input configured to receive a second audio signal and provide the second audio signal to the mixing circuit, the mixing circuit configured to mix the first audio signal and the second audio signal to produce a mixed signal, and the wireless transmitter configured to transmit the mixed signal to the wireless receiver with low latency.

### CROSS-REFERENCE TO RELATED APPLICATION

This application claims priority under 35 U.S.C. § 119(e) to U.S. Provisional Application 63/567,655, titled WIRELESS SIDETONE SYSTEM FOR DESKTOP MICROPHONES AND HEADSETS, filed on Mar. 20, 2024, which is hereby incorporated by reference in its entirety for all purposes.

### BACKGROUND

### 1. Field of the Disclosure

At least one example in accordance with the present disclosure relates generally to sidetone for wireless headphones.

### 2. Discussion of Related Art

Headphones are devices capable of converting electrical signals into sound. Microphones are devices capable of converting sound into electrical signals.

### SUMMARY

According to at least one aspect of the present disclosure, a system for providing a sidetone to a headset is presented, comprising: a headset having an audio output and a wireless receiver; and a microphone having a first audio input, a second audio input, a mixing circuit, and a wireless transmitter, the first audio input configured to receive a first audio signal and provide the first audio signal to the mixing circuit, the second audio input configured to receive a second audio signal and provide the second audio signal to the mixing circuit, the mixing circuit configured to mix the first audio signal and the second audio signal to produce a mixed signal, and the wireless transmitter configured to transmit the mixed signal to the wireless receiver with low latency.

In some examples, the system further comprises a computer having a playback signal transmitter configured to provide the first audio signal to the microphone via the first audio input. In some examples, the microphone further includes an output configured to provide the second audio signal to the computer, and the computer includes an audio signal receiver configured to receive the second audio signal from the output. In some examples, the computer further includes a computer wireless transmitter configured to transmit the first audio signal to the wireless receiver and the computer wireless transmitter has a latency of greater than 10 milliseconds. In some examples, the headset includes a second mixing circuit and a headset audio input, the headset audio input configured to provide a headset audio signal to the second mixing circuit and the wireless receiver configured to provide the first audio signal to the second mixing circuit. In some examples, the second mixing circuit is configured to mix the headset audio signal and the first audio signal together to produce a second mixed circuit and to provide the second mixed circuit to the audio output. In some examples, when the headset audio input is enabled, the microphone is disabled. In some examples, the headset includes a second wireless receiver configured to receive transmissions from the computer wireless transmitter and wherein the wireless receiver is configured to receive transmissions from the wireless transmitter. In some examples, the microphone is disabled when the computer wireless transmitter is enabled. In some examples, low latency is a latency of 10 milliseconds or less. In some examples, low latency is a latency of 5 milliseconds or less. In some examples, low latency is a latency of 3 milliseconds or less.

According to at least one aspect of the present disclosure, an audio-mixing system is presented, comprising: a microphone having a voice input configured to receive a first audio input from a user, a system input configured to receive a second audio input, a mixing circuit configured to combine the first audio input and the second audio into to produce mixed audio data, and a first radio configured to transmit mixed audio data from the microphone; and a headset configured to receive the mixed audio data from the microphone, the headset configured to provide the mixed audio data as a first audio output to the user.

In some examples, the headset further comprises a headset mixing circuit configured to mix audio signals received by the headset, wherein the headset mixing circuit is configured to be operable when the microphone is disabled, and the headset mixing circuit is configured to be bypassed when the microphone is enabled. In some examples, the headset further comprises a headset microphone, the headset microphone being configured to receive the first audio input from the user and to provide the first audio input to the headset mixing circuit. In some examples, bypassing the headset mixing circuit includes not mixing the first audio input received at the headset microphone with the mixed audio signal from the microphone. In some examples, the headset further comprises a second radio and a third radio, wherein the second radio is configured to receive the mixed audio data from the microphone, and the third radio is configured to receive the second audio data. In some examples, the system further comprises an electronic device configured to provide the second audio data to the headset and to the microphone. In some examples, the electronic device transmits the second audio data using a radio with a latency greater than or equal to 10 milliseconds. In some examples, the first radio of the microphone has a latency of less than 10 milliseconds.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 a system for mixing audio signals according to an example;

FIG. 2 a system for mixing audio signals according to an example;

FIG. 3 a system for mixing audio signals according to an example; and

FIG. 4 a process for mixing audio signals according to an example.

### DETAILED DESCRIPTION

When wearing a headset that covers both ears or wearing earbuds that are inserted into both ears, it can be difficult to hear oneself, which can make it difficult to choose the correct volume or pitch with which to speak or sing (e.g., when recording audio). As a result, a microphone can provide part of the audio signal to the headset, so that the speaker can hear him or herself. This audio signal is called a sidetone. However, when latency between the microphone capturing the audio signal and providing the audio signal to the speaker exceeds a threshold latency, a choral effect can occur. The choral effect occurs when a person hears their own voice fed back to them at too high a latency (e.g., at a latency exceeding the threshold latency). Feeding a person's voice back to them at these high latencies can interfere with that person's speech patterns, making it difficult or impossible for the person to speak.

The sidetone can be mixed with other sounds. For example, suppose the speaker is speaking while receiving other audio. One example would be a situation where the speaker is playing a video game and is voice chatting with friends while also receiving audio from the video game. In this example, the sidetone could be mixed with the audio from the video game. More generally, the sidetone can be mixed with any other audio signal the speaker is receiving via their headset.

In some examples, the sidetone is mixed using a wired system or other specialized system (e.g., a system with a sound board) where latency may not be a concern. For example, when a microphone receives a signal and transmits the signal via a wired connection to a computer, and the computer then transmits the signal via a wired connection to the headset, latency may be relatively low as transmission time will be minimal. In such examples, the greatest source of latency may be the computer that is relaying the audio signal.

In contrast, wireless systems generally have longer transmission delays because wireless signals tend to take longer to transmit than wired signals. As a result, in systems where the headset and/or microphone are connected wirelessly to one-another and/or a computer, the latency can be too high to facilitate providing a sidetone without causing the choral effect.

Systems and methods disclosed herein relate generally to wireless systems where the latency is reduced such that sidetone may be provided to a headset without inducing the choral effect. In some examples, the systems disclosed herein include a microphone and a separate, wireless headset. The microphone can receive input audio signals from the user (e.g., the speaker, via the microphone itself) and from a second audio source (e.g., via a connection between the microphone and the computer). The microphone may mix those signals together to create an output audio signal with a sidetone incorporated into it, and may wirelessly provide the output audio signal to the headphones with sufficiently low latency so as not to induce the choral effect.

Other examples disclosed herein may also perform mixing in the headset instead of in the microphone, and may involve one or more connections between headset, microphone, and another audio source (such as a computer).

Furthermore, the systems and methods disclosed herein apply to consumer-grade electronic devices. Previously, systems capable of performing the operations described herein relied on expensive professional-grade electronics that used specialized techniques to function, and which generally consume more power, are larger, and are more expensive than the systems and devices disclosed herein. The systems and devices disclosed herein therefore represent a substantial improvement over the state-of-the-art by raising consumer-grade electronics to the professional-grade level and/or narrowing the gap in performance between consumer and professional-grade electronics.

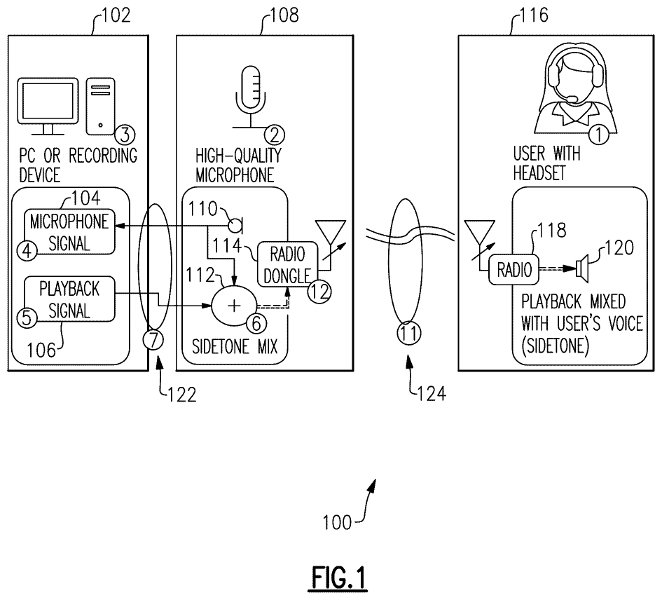

FIG. 1 illustrates an audio system 100 (“system 100”) according to an example. The system 100 includes a computer 102, a microphone 108, and a headset 116. The computer 102 includes a microphone signal receiver 104, and a playback signal transmitter 106. The microphone 108 includes an audio input 110, a mixing circuit 112, and a first radio transceiver 114 (“first radio 114”). The headset 116 includes a second radio transceiver 118 (“second radio 118”) and an audio output 120. A first link 122 connects the computer 102 and the microphone 108. A second link 124 connects the microphone 108 and the headset 116.

The computer 102 may be any type of device capable of sending and receiving audio signals. In some examples, the computer 102 may be a personal computer such as a laptop or desktop computer, tablet computer, smartphone, and so forth. In some examples, the computer 102 may be a processing unit, microcontroller, microprocessor, ASIC, FPGA, or other specialized circuitry or electrical equipment (e.g., a sound board).

The microphone signal receiver 104 of the computer 102 is configured to receive an audio signal from an external device such as the microphone 108. The playback signal transmitter 106 is configured to provide an audio signal to an external device, such as the microphone 108 and/or headset 116.

The microphone 108 is configured to receive audio inputs from a user and provide those audio inputs as electrical signals (e.g., audio signals) to the computer 102 and/or headset 116. The microphone 108 may be any type of microphone, such as an active and/or passive microphone.

The audio input 110 is the input of the microphone 108. For example, the audio input 110 may be a membrane configured to vibrate in response to changes in air pressure caused by a human voice or other sounds. The audio input 110 may be configured to translate physical sounds into electrical signals and provide those signals to the mixing circuit 112 and/or computer 102. When the audio input 110 provides audio to the computer 102, the audio input 110 may provide the audio signal to the microphone signal receiver 104.

The mixing circuit 112 is configured to mix the first audio signal from the audio input 110 with one or more second audio signals (“second audio signal”). The second audio signal may be provided by the computer 102. In some examples, the second audio signal may be provided by the playback signal transmitter 106 to the mixing circuit 112. The mixing circuit 112 may, in some examples, process both the first audio signal and second audio signal (e.g., provide attenuation, gain, and so forth), and may transmit the mixed signal to the first radio 114. The audio mixing of the sidetone (e.g., the first audio signal) with the second audio signal occurs in the microphone 108 (e.g., because the mixing circuit 112 is located within the microphone 108). The mixed signal is then provided directly to the first radio 114 for transmission to the second radio 118.

The first radio 114 may be a wireless signal transmitter, receiver, and/or transceiver. That is, the first radio 114 may be configured to receive, transmit, or both receive and transmit wireless signals. The first radio 114 may be configured to encode data (such as the mixed signal) according to a given communication protocol before transmitting the data. The first radio 114 may be configured to decode data after receiving the data (e.g., from the radio 118) as well. The first radio 114 may transmit data to and/or receive data from the second radio 118.

The second radio 118 may be a wireless signal transmitter, receiver, and/or transceiver. That is, the second radio 118 may be configured to receive, transmit, or both receive and transmit wireless signals. The second radio 118 may be configured to encode data according to a given communication protocol before transmitting the data. The second radio 184 may be configured to decode data (e.g., the mixed signal) after receiving the data as well. The second radio 118 may transmit data to and/or receive data from the first radio 114. The second radio 118 may be configured to provide audio signals to the audio output 120.

The first radio 114 and second radio 118 are low latency radios. That is, the first radio 114 and second radio 118 may transmit and receive signals with very low latency, such that the time between the audio input 110 receiving an input signal, and the mixed signal incorporating that input signal being received by the headset 116 may be less than 10 ms (e.g., 1 ms, 5 ms, 6 ms, and so forth). The first radio 114 and second radio 118 may, in some examples, be implemented as removable (e.g., modular) dongles, such as USB dongles.

The headset 116 may be any type of headset, including an over-the-head headset, earbuds, and so forth.

The audio output 120 may be an audio speaker (or audio speakers) configured to translate electrical signals into audible signals. For example, the audio output 120 may be a membrane that vibrates based on the audio signal and generates sounds based on the audio signal. The audio output 120 may be an active or passive component.

The first link 122 is a connection between the computer 102 and the microphone 108. In some examples, the first link 122 may be a wired connection, and in some examples the first link 122 may be a wireless connection. The first link 122 may include at least a connection between the audio input 110 and the microphone signal receiver 104, and/or a connection between the mixing circuit 112 and the playback signal transmitter 106. Said connections may be independent of one another (that is, the first link 122 may include a plurality of connections which may be application or hardware specific).

The second link 124 is a connection between the microphone 108 and the headset 116. The second link 124 is a wireless connection, and may represent a wireless connection between the first radio 114 and the second radio 118. Data transmitted from the first radio 114 to the second radio 118 or from the second radio 118 to the first radio 114 may traverse the second link 124 at a low latency based on the performance of the first radio 114 and/or second radio 118.

As one example of operation, and to illustrate the data transmission paths when providing a sidetone to the headset 116, consider a situation where the user (wearing the headset 116) is speaking into the microphone 108 while receiving audio from the computer 102.

The user's voice is picked up by the audio input 110 of the microphone 108. The audio input 110 provides the voice signal to the mixing circuit 112 and the microphone signal receiver 104. The microphone signal receiver 104 may make the voice signal available to the computer 102 (e.g., for use by a VoIP client). As the user is speaking, the computer 102 provides an audio signal from the playback signal transmitter 106 to the mixing circuit 112. The mixing circuit 112 mixes the audio signal with the voice signal to produce a mixed signal, which is then transmitted to the first radio 114. The first radio 114 transmits the mixed signal to the second radio 118, where the second radio 118 receives the mixed signal and provides it to the audio output 120. The audio output 120 translates the mixed signal into an audible output signal that the user can hear. All of this is performed with sufficiently low latency so as not to induce the choral effect (e.g., latency less than approximately 10 ms, or more preferably less than 5 ms, and in some examples, less than 3 ms). Furthermore, no specialized (e.g., professional-grade) equipment is required.

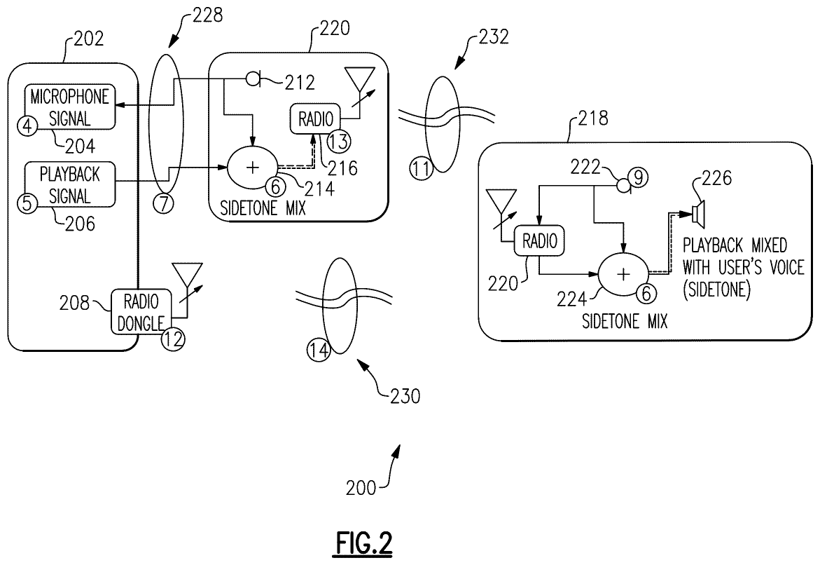

FIG. 2 illustrates an audio system 200 (“system 200”) according to an example. The system 200 includes a computer 202, a microphone 210, and a headset 218. The computer 202 includes a microphone signal receiver 204, a playback signal transmitter 206, and a first radio transceiver 208 (“first radio 208”). The microphone 210 includes a first audio input 212, a first mixing circuit 214, and a second radio transceiver 216 (“second radio 216”). The headset 218 includes a third radio transceiver 220 (“third radio 220”), a second audio input 222, a second mixing circuit 224, and an audio output 226. The system 200 also includes a first link 228 between the computer 202 and microphone 210, a second link 230 between the computer 202 and the headset 218, and a third link 232 between the microphone 210 and the headset 218. The first link 228 may be a physical link (e.g., coupling the first audio input 212 to the microphone signal receiver 204, and coupling the playback signal transmitter 206 to the first mixing circuit 214). The second link 230 may be a wireless link (e.g., connecting the first radio 208 and the third radio 220). The third link 232 may be a wireless link (e.g., connecting the second radio 216 and the third radio 220). As with FIG. 1, the microphone 210 and headset 218 are separate components.

The system 200 differs from the system 100 of FIG. 1 in various ways. In some examples, the system 200 includes additional microphones and mixing circuits within the headset 218, and an additional wireless link between the computer 202 and the headset 218. When the microphone 210 is operative (e.g., turned on and/or in use) the microphone of the headset 218 may be ignored or disabled. Likewise, the second mixing circuit 224 of the headset 218 may be bypassed or disabled. In this mode, where the microphone 210 is operative, the microphone 210 may perform the mixing of the sidetone with the audio from the computer 202, and then provide a mixed signal produced based on the sidetone and computer 202 audio to the headset 218 via the second radio 216 and/or third radio 220. This mode of operation allows mixing to be performed at the microphone 210 to reduce latency when the microphone 210 is in use. For example, mixing at the microphone 210 may be desired where the microphone 210 is a higher performance microphone than the microphone of the headset 218.

When the microphone 210 is not operative (e.g., not turned on and/or not in use), the headset 218 may instead be the source of the sidetone via the second audio input 222 (e.g., the microphone of the headset 218). The computer 202 may transmit the audio signal from the playback audio transmitter 206 to the headset 218 via the first radio 208 and/or third radio 220, and the second mixing circuit 224 may mix the sidetone (received from the second audio input 222) with said transmitted signal. Because the second audio input 222 is incorporated into the headset 218, it may be acceptable to perform the mixing at the second mixing circuit 224 because latency between internal or incorporated components of the headset 218 may be low.

Thus, in summary, when the microphone 210 is operative, to avoid latency the microphone 210 may perform the mixing and transmit the mixed signal to the headset 218. When the microphone 210 is not operative, the computer 202 may transmit directly to the headset 218 and the headset 218 may perform the mixing. Both modes of operation do not require the computer 202 to process the sidetone (e.g., the audio input received by the first audio input 212 and/or the second audio input 222), and thus avoid latency associated with the computer 202 and the first link 228 and second link 230.

The computer 202 may be a device substantially similar to the computer 102 of FIG. 1. The computer 202 includes a microphone signal receiver 204 that is configured to receive a signal from the microphone 210. For example, the microphone signal receiver 204 may be configured to receive a signal from the first input 212 of the microphone.

The computer 202 also includes a playback signal transmitter 206. The playback signal transmitter 206 is configured to provide a signal to the first mixing circuit 214 of the microphone 210 and/or to provide the signal to the first radio 208. The signal provided by the playback signal transmitter 206 may be an audio signal generated and/or received by the computer 202, for example, audio from a video game, a VoIP call, a music file (e.g., an MP3), a movie file (e.g., an AVI), and so forth.

The computer 202 also includes the first radio 208. The first radio 208 may be a low-latency radio (e.g., a radio with a latency of less than 10 ms, for example, 6 ms or less), or a relatively higher latency radio. In some examples, the first radio 208 may be a relatively higher latency radio. The first radio 208 is configured to transmit signals (for example, signals provided from the playback signal transmitter 206) across a wireless medium to the headset 218 and/or microphone 210.

The microphone 210 may be a device substantially similar to the microphone 108 of FIG. 1. The microphone 210 includes a first audio input 212. The first audio input 212 is a device, such as a diaphragm, magnet, or a membrane configured to vibrate in response to changes in air pressure caused by a human voice or other sounds. The first audio input 212 may be configured to translate physical sounds into electrical signals and provide those signals to the first mixing circuit 214 and/or computer 202. When the first audio input 212 provides audio to the computer 202, the first audio input 212 may provide the audio signal to the microphone signal receiver 204.

The microphone 210 includes a first mixing circuit 214. The first mixing circuit 214 is configured to mix a sidetone with an audio signal. For example, the first mixing circuit 214 may receive an audio signal from the first audio input 212 (this signal may be the sidetone or may be the basis for the sidetone), and the first mixing circuit 214 may receive a second audio signal from the playback signal transmitter 206. The first mixing circuit 214 may combine the first and second audio signals together, and may apply additional conditioning to the signal (e.g., attenuating or enhancing certain frequency components of the signal, and so forth). The first mixing circuit 214 may provide the mixed signal to the second radio 216.

The microphone 210 includes a second radio 216. The second radio 216 will, in some examples, be a low latency radio (e.g., a radio having latency of less than 10 ms). The second radio 216 is configured to receive the mixed signal from the first mixing circuit 214 and transmit the mixed signal across a wireless medium (e.g., to the first radio 208 or third radio 220).

The headset 218 may be any type of headset (e.g., over-the-ear, earbud, and so forth). The headset 218 has both an built-in and/or associated microphone (the second audio input 222) and a radio (the third radio 220) for receiving audio signals. The headset 218 also include a mixing circuit (the second mixing circuit 224) configured to mix a sidetone with an audio signal. In some examples, the sidetone is the audio signal provided by the second audio input 222 and the audio signal is the signal provided by the third radio 220. The second mixing circuit 224 may include all the capabilities of other mixing circuits discussed herein, and thus may also condition the audio signals it receives. The second mixing circuit 224 may provide a mixed signal to the audio output 226. The audio output 226 is a device, such as a diaphragm, membrane, or magnet, configured to convert an electrical signal (such as the sidetone, audio signal, and/or mixed signal) into an audible form.

As discussed above, various links 228, 230, 232, audio inputs 212, 222, and mixing circuits 214, 224 may be active depending on the mode of operation of the system 200. The system 200 has at least a first mode of operation and a second mode of operation. Both modes of operation are characterized in that they avoid the need to send audio signals to the computer 202 for mixing and/or retransmission.

In some examples, the first mode of operation is further characterized by the first link 228 and third link 232 being active, the first mixing circuit 214 and first audio input 212 being active, the second link 230 being inactive, and the second audio input 222 and second mixing circuit 224 being inactive. In the first mode of operation, the system 200 may operate in a manner identical to that of system 100 of FIG. 1.

By contrast, in some examples, the second mode of operation is further characterized by the second link 230, second audio input 222, and second mixing circuit 224 all being active, and the first audio input 212 and first mixing circuit 214 being inactive. Additionally, in some examples, the first link 228 and third link 232 may be inactive (e.g., to save power or reduce potential interference between the various radios 208, 216, 220). In the second mode of operation, the headset 218 may be receiving the sidetone (e.g., from the second audio input 222) locally, and so latency will be low or non-existent. The headset 218 may be receiving other audio from the computer 202 (e.g., via the second link 230). Because the connection between second input 222 and second mixing circuit 224 will be a fast (e.g., low latency) connection, the headset 218 will generally have adequate time to mix the sidetone with the audio from the computer 202 provided via the second link 230.

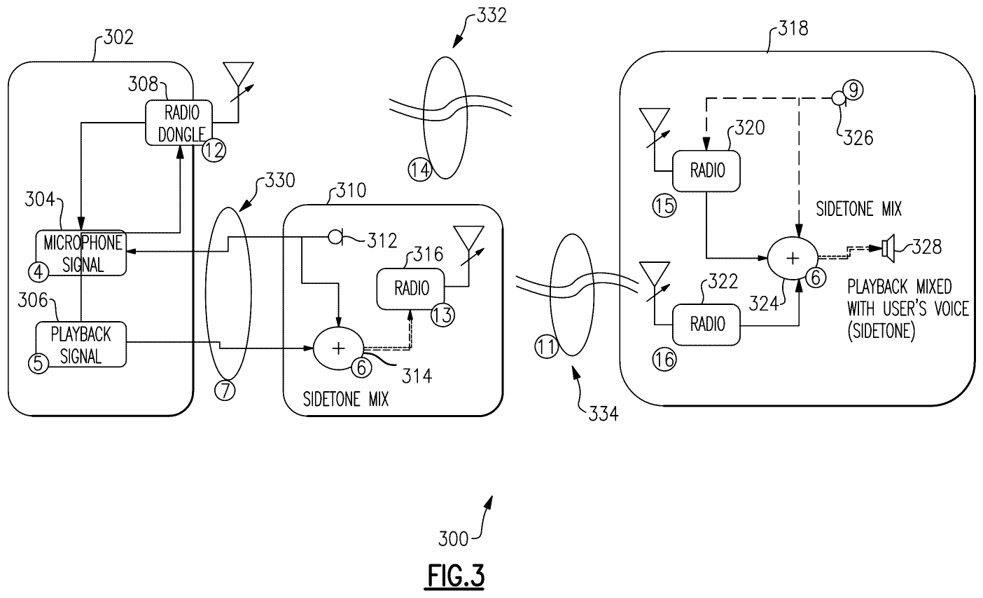

FIG. 3 illustrates an audio system 300 (“system 300”) according to an example. One difference between the system 300 and the system 200 of FIG. 2 is that the system 300 includes a headset 318 with two radios, allowing the headset 318 to maintain simultaneous connections with both the computer 302 and the microphone 310.

The system 300 includes a computer 302, a microphone 310, and a headset 318. The computer 302 includes a microphone signal receiver 304, a playback signal transmitter 306, and a first radio 308. The microphone 310 includes a first audio input 312, a first mixing circuit 314, and a second radio 316. The headset 318 includes a third radio 320, a fourth radio 322, a second mixing circuit 324, a second audio input 326, and an audio output 328. The system 300 also includes a first link 330, a second link 332, and a third link 334. The first link 330 may be a physical or wireless connection between the microphone 310 and the computer 302 (e.g., connecting the first audio input 312 to the microphone signal receiver 304 and/or connecting the playback signal transmitter 306 to the first mixing circuit 314). The second link 332 may be a connection between the computer 302 and the headset 318 (e.g., a wireless connection between the first radio 308 and the third radio 320). The third link 334 may be a connection between the microphone 310 and the headset 318 (e.g., a wireless connection between the second radio 316 and the fourth radio 322).

The components of the system 300 function in similar manners to respective components of the other systems 100, 200. With respect to the computer 302, the microphone signal receiver 304 is configured to receive a signal from one or more audio inputs 312, 326 and provide that and/or those signals so that the computer 302 for use (e.g., in a VoIP, in a game, in a voice recorder or music program, and so forth). The playback signal transmitter 306 is configured to provide an audio signal to the headset 318 and/or the microphone 310 (e.g., through the first radio 308 via the first link 330, or through the second link 332). The audio signal provided by the playback signal transmitter 306 may be a signal from a computer 302 application, such as a video game, VoIP client, and so forth. The first radio 308 may be a low latency radio or may have relatively higher latency (e.g., may have latency above or below approximately 10 ms).

With respect to the microphone 310, the first audio input 312 is configured to sense sounds in an environment of the microphone and convert those sounds into electrical signals (e.g., audio signals and/or a sidetone). The first audio input 312 may provide audio signals to the microphone signal receiver 304 and/or the first mixing circuit 314. The first mixing circuit 314 is configured to mix one or more audio signals together. For example, the first mixing circuit 314 may receive a first audio signal from a first source (e.g., an audio signal from the playback signal transmitter 306), and may receive a second audio signal from a second source (e.g., an audio signal from the first audio input 312), and may mix the two signals together. The first mixing circuit 314 may condition the signals (e.g., provide attenuation, gain, or other alterations, to one or more components of the signals). The first mixing circuit 314 may provide the resulting mixed signal to the second radio 316. The second radio 316 may be a low latency radio (e.g., have a latency of less than approximately 10 ms), and may provide the mixed signal, via the third link 334, to the fourth radio 322 of the headset 318.

With respect to the headset 318, the second audio input 326 is configured to sense sounds in the environment (e.g., in the local environment of the headset microphone) and convert those sounds into electrical signals (e.g., audio signals and/or sidetone). The second audio input 326 is configured to provide the signals it produces (e.g., the sidetone) to the second mixing circuit 324. The second mixing circuit 324 is configured to receive two audio signals and mix them together. The second mixing circuit 324 may also condition some or all of the signals it receives. The second mixing circuit 324 may also be bypassed or deactivated if, for example, the headset 318 is receiving a pre-mixed signal from the microphone 310 (e.g., via the third link 334). The second mixing circuit 324 may provide a mixed signal to the audio output 328. The audio output 328 is configured to convert an electrical signal into an audible sound (e.g., convert the mixed signal to sound audible to the human ear).

The headset 318 also includes two radios 320, 322. The third radio 320 is configured to communicate with at least the first radio 308 to maintain the second link 332. The third radio 320 may be a low latency radio. The third radio 320 is configured to provide audio signals it receives via the second link 332 to the second mixing circuit 324. The fourth radio 322 is configured to communicate with at least the second radio 316 via the third link 334. The fourth radio 322 may be a low latency radio. The fourth radio 322 is configured to provide audio signals it receives via the third link 334 to the second mixing circuit 324.

The third and fourth radios 320, 322 may operate simultaneously or at different times, or may operate in partially overlapping manner (such that both are on at some times when the other is not on, and both are on at some times when the other is also on). In some examples, the third and fourth radios 320, 322 may both be unidirectional, both be bidirectional, or one may be bidirectional and the other unidirectional.

The system 300 may have two or more modes of operation, including a first mode of operation, a second mode of operation, and a third mode of operation. In the first mode of operation, the first radio 308 and third radio 320 may be inoperative (e.g., off, deactivated, and/or ignored) and the second radio 316 and fourth radio 322 may be operative (e.g., on, activated, and/or engaged). The second audio input 326 may be inoperative as well, while the first input may be operative. The first mode may function in a similar manner to system 100 of FIG. 1, where the computer 302 provides audio signals to the microphone 310, and the second mixing circuit 314 mixes those audio signals with sidetone derived from the first audio input 312. The mixed signal may then be transmitted across the third link 324 (e.g., via the second radio 316 and/or fourth radio 322) to the headset 318, where the signal may be provided to the audio output 328 and converted into sound.

In the second mode of operation, the second radio 316 and fourth radio 322 may be inoperative, and the first radio 308 and third radio 320 may be active. The microphone 310 may be inoperative, while the second audio input 326 may be active. That is, the headset 318 may be the source of audio inputs and audio outputs with respect to the user. In this mode of operation, the system 300 may operate in a manner substantially similar to that of the second mode of operation described with respect to the system 200 of FIG. 2. In the second mode of operation, the audio signal produced by the second input 326 may be provided to the second mixing circuit 324 and/or to the third radio 320. The third radio 320 may transmit said audio signal to the first radio 308, where the signal may be provided to the microphone signal receiver 304. The playback signal transmitter 306 may transmit an audio signal to the first radio 308. The first radio 308 may relay that signal to the third radio 320, and the third radio 320 may relay the signal to the second mixing circuit 324. The second mixing circuit 324 may mix together the signal from the second input 326 with the signal from the playback signal transmitter 306 and may provide the resulting mixed signal to the audio output 328.

In a third mode of operation, all of the radios 308, 316, 320, 322 may be operative. In this mode either or both of the audio inputs 312, 326 may be operative, however, in general only one of the audio inputs 312, 326 will be active. In some examples, the active audio input will be the first audio input 312. In the third mode of operation, the microphone 312 may transmit audio received from the first audio input 312 to the headset 318 via the third link 334, and the computer 302 may transmit audio from the playback signal transmitter 306 to the headset 318 via the second link 332. The headset 318 may then, via the second mixing circuit 324, mix the signals from the microphone 310 and computer 302 together and provide the resulting mixed signal to the audio output 328. The microphone 310 may also provide audio received at the first audio input 312 to the microphone signal receiver 304 of the computer 302 so that the computer 302 may use the audio from the microphone 310. In some examples, the third link 334 is unidirectional (e.g., the third link 334 permits data to transmit from the second radio 316 to the fourth radio 322 or from the fourth radio 322 to the second radio 316, but not in both directions), and the second link 332 is bidirectional (e.g., permits data to be transmitted both from the first radio 308 to the third radio 320 and from the third radio 320 to the first radio 308). In the third mode of operation, the headset 318 may also pass a signal received at one radio (e.g., at the fourth radio 322) back through the other radio (e.g., the third radio 320) to the computer 302.

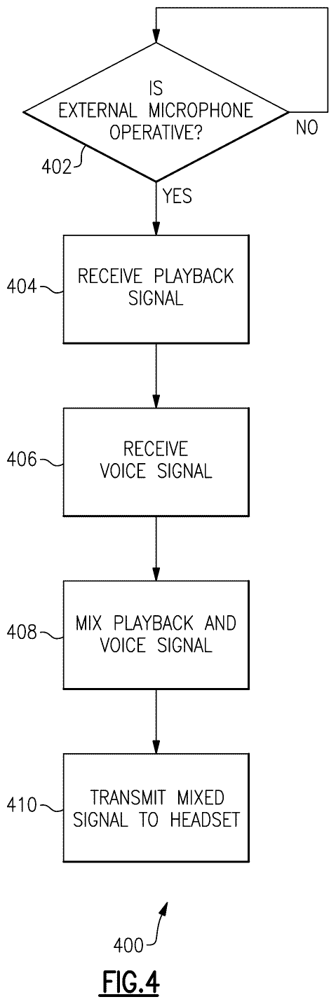

FIG. 4 illustrates a process 400 for mixing and transmitting audio signals according to an example.

At act 402, at least one controllers (“controller”) determines whether an external microphone (e.g., microphone 108) is operative (e.g., active, turned-on, and so forth). The controller may be situated in the microphone, in a computer (e.g., computer 102), in a headset (e.g., headset 116), or in another location. If the controller determines the external microphone is not enabled (402 NO), the process 400 may repeat act 402 (e.g., until the external microphone is enabled, or possibly until another condition is met). If the controller determines that the external microphone is enabled (402 YES), the process 400 may continue to act 404.

At act 404, the external microphone receives a playback signal (e.g., the microphone 108 may receive a playback signal from the playback signal transmitter 106). The process 400 may then continue to act 406.

At act 406, the external microphone receives an audio signal, such as a voice signal or sidetone signal. In many examples, the external microphone not only receives the audio signal but also is used to generate the audio signal. For example, an audio input (such as audio input 110) is situated on the external microphone and may convert a sound into an electrical signal which is made available to other components of the external microphone. The process 400 may then continue to act 408.

At act 408, the external microphone mixes the playback signal and the audio signal together. In some examples, the external microphone may use a mixing circuit (such as mixing circuit 112) to mix the playback signal and audio signal. In some examples, the external microphone may mix the audio signal into the playback signal such that the audio signal is used as a sidetone. The process 400 may then continue to act 410.

At act 410, the external microphone transmits the mixed signal (e.g., the combination of the playback signal and the audio signal) to a headset (e.g., headset 116). In some examples, the external microphone transmits the mixed signal to the headset using a low latency radio (e.g., a radio with latency of under 10 ms, 6 ms, and so forth).

In some examples, a computer 102, 202, 302 may be a controller (or include one more controllers) for controlling the mode of operation of the system. In some examples, the headsets 116, 218, 318, microphones 108, 210, 310, and/or computers 102, 202, 302 may include one or more controllers configured to control the mode of operation of the system.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers may execute various operations discussed above. Using data stored in associated memory and/or storage, the controller also executes one or more instructions stored on one or more non-transitory computer-readable media, which the controller may include and/or be coupled to, that may result in manipulated data. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1. A system for providing a sidetone to a headset, comprising:
a headset having an audio output and a wireless receiver; and
a microphone having a first audio input, a second audio input, a mixing circuit, and a wireless transmitter,
the first audio input configured to receive a first audio signal and provide the first audio signal to the mixing circuit,
the second audio input configured to receive a second audio signal and provide the second audio signal to the mixing circuit,
the mixing circuit configured to mix the first audio signal and the second audio signal to produce a mixed signal, and
the wireless transmitter configured to transmit the mixed signal to the wireless receiver with low latency.

2. The system of claim 1 further comprising a computer having a playback signal transmitter configured to provide the first audio signal to the microphone via the first audio input.

3. The system of claim 2 wherein the microphone further includes an output configured to provide the second audio signal to the computer, and the computer includes an audio signal receiver configured to receive the second audio signal from the output.

4. The system of claim 2 wherein the computer further includes a computer wireless transmitter configured to transmit the first audio signal to the wireless receiver and the computer wireless transmitter has a latency of greater than 10 milliseconds.

5. The system of claim 4 wherein the headset includes a second mixing circuit and a headset audio input, the headset audio input configured to provide a headset audio signal to the second mixing circuit and the wireless receiver configured to provide the first audio signal to the second mixing circuit.

6. The system of claim 5 wherein the second mixing circuit is configured to mix the headset audio signal and the first audio signal together to produce a second mixed circuit and to provide the second mixed circuit to the audio output.

7. The system of claim 6 wherein when the headset audio input is enabled, the microphone is disabled.

8. The system of claim 4 wherein the headset includes a second wireless receiver configured to receive transmissions from the computer wireless transmitter and wherein the wireless receiver is configured to receive transmissions from the wireless transmitter.

9. The system of claim 7 wherein the microphone is disabled when the computer wireless transmitter is enabled.

10. The system of claim 1 wherein low latency is a latency of 10 milliseconds or less.

11. The system of claim 1 wherein low latency is a latency of 5 milliseconds or less.

12. The system of claim 1 wherein low latency is a latency of 3 milliseconds or less.

13. An audio-mixing system comprising:
a microphone having a voice input configured to receive a first audio input from a user, a system input configured to receive a second audio input, a mixing circuit configured to combine the first audio input and the second audio into to produce mixed audio data, and a first radio configured to transmit mixed audio data from the microphone; and
a headset configured to receive the mixed audio data from the microphone, the headset configured to provide the mixed audio data as a first audio output to the user.

14. The system of claim 13 wherein the headset further comprises a headset mixing circuit configured to mix audio signals received by the headset, wherein the headset mixing circuit is configured to be operable when the microphone is disabled, and the headset mixing circuit is configured to be bypassed when the microphone is enabled.

15. The system of claim 14 wherein the headset further comprises a headset microphone, the headset microphone being configured to receive the first audio input from the user and to provide the first audio input to the headset mixing circuit.

16. The system of claim 15 wherein bypassing the headset mixing circuit includes not mixing the first audio input received at the headset microphone with the mixed audio signal from the microphone.

17. The system of claim 14 wherein the headset further comprises a second radio and a third radio, wherein the second radio is configured to receive the mixed audio data from the microphone, and the third radio is configured to receive the second audio data.

18. The system of claim 17 wherein the system further comprises an electronic device configured to provide the second audio data to the headset and to the microphone.

19. The system of claim 18 wherein the electronic device transmits the second audio data using a radio with a latency greater than or equal to 10 milliseconds.

20. The system of claim 13 wherein the first radio of the microphone has a latency of less than 10 milliseconds.
